(19) United States
(12) Patent Application Publication
(10) Pub. No.: US 2007/0159703 A1
(43) Pub. Date: Jul. 12, 2007

(54) Optical module and method for assembling an optical module

(76) Inventors: Uwe Apel, Neckartailfingen (DE); Stefan Keith, Renningen (DE)

Correspondence Address: KENYON & KENYON LLP, ONE BROADWAY, NEW YORK, NY, 10004, US

(21) Appl. No.: 11/605,772

(22) Filed: Nov. 28, 2006

(30) Foreign Application Priority Data
Dec. 12, 2005 (DE) 102005059161.2

(51) Int. Cl. G02B 7/02

(52) U.S. Cl. 359/819; 359/820

(57) ABSTRACT

An optical module includes a lens holder having at least one lens, a housing having a mounting surface, and an image sensor unit. The lens holder a peripheral edge on its side facing the housing in the assembled state, which is insertable into a corresponding groove located in the mounting surface of the housing. A method for assembling an optical module including components made up of a lens holder having at least one lens, a housing having a mounting surface, and an image sensor unit.

### BACKGROUND INFORMATION

According to the related art, optical modules having one or more lenses, an objective, a lens holder, and a housing are known. Normally, the individual optical components are connected successively—specifically, the lenses to the objective, the objective to the lens holder, and the lens holder to the housing. A connection between lenses and objective is normally implemented using a packing ring. To secure the objective on the lens holder, a thread is usually provided, the objective being focused by screwing it into the thread. The lens holder is connected to the housing, which is usually designed as a ceramic housing, with the aid of an adhesive. Three sensitive joints having a sealing function and therefore three critical leak paths are thus obtained in the conventional optical modules. The problem here is that the adhesives and sealants usable in practice exhibit a non-negligible water vapor diffusion. There is therefore a risk of moisture penetrating due to this water vapor diffusion, which reduces the service life of the sensitive optical components located within the module, such as the image sensor unit chip.

European Patent Application No. EP 1 498 959 describes a method for manufacturing a semiconductor device, where a sealing element is mounted onto a substrate carrying the semiconductor element. The sealing element is glued to the substrate, the adhesive being subsequently cured. To compensate for a possible increase in pressure within the semiconductor device during curing, an opening is provided in the sealing element. The opening is subsequently reclosed to seal the semiconductor device.

### SUMMARY OF THE INVENTION

The optical module according to the present invention includes a lens holder having at least one lens, a housing having a mounting surface, and an image sensor unit, the lens holder having a peripheral edge on a side facing the housing in the assembled state, which is insertable into a corresponding groove located in the mounting surface of the housing. The groove preferably runs peripherally and may be filled with a sealant, preferably an adhesive, which allows for a tight connection between the lens holder and the housing to be established.

The lenses of the objective are preferably directly connected to the lens holder, for example, via a packing ring or an adhesive. A pre-assembled component which is preferably connectable to the housing as a single piece is thus formed.

It is especially advantageous that there are only two glued interfaces so that the number of joints is able to be reduced. The leak paths which may occur may also be reduced due to the reduction of these joints having a sealing effect. The introduction of moisture, for example, through water vapor diffusion, may thus be minimized, thereby increasing the service life of the sensitive optical components. In addition, condensation in the module at low temperatures may be avoided.

Ceramic, glass, and/or metal, which advantageously exhibit no water vapor diffusion, are preferably used as the materials for the individual components. The use of housing components made of these materials allows assembly and focusing using efficient and cost-effective steps.

In a method according to the present invention for assembling such an optical module, a peripheral frame of the lens holder is joined into a corresponding groove located in the mounting surface of the housing and filled with a sealant, in particular an adhesive.

A desired focusing of the lens may preferably be set automatically during the joining process of the lens holder to the housing. The desired focusing is preferably established via an image sensor unit actively operated during the joining process, which generates test charts. The image sequence of the test charts may be subsequently analyzed to ascertain correct focusing. The fact that complicated focusing of the optics by screwing it into a thread may be avoided is especially advantageous. In addition, very accurate focusing is advantageously achieved by using this method.

In an advantageous refinement of the method according to the present invention, one of the pre-assembled components, for example, the lens holder or the ceramic housing, is rigidly clamped or secured in the joining process, and the other component is aligned via a suitable dynamic positioning device, for example, an IAF (Image Align Fixture). Alignment is preferably accomplished by achieving the desired sharpness distribution over the viewing field. At the same time, lateral alignment of the lens holder with respect to the housing may be advantageously set, for example, to avoid skewed viewing of the optical module.

In a preferred embodiment, the edge, in particular its height and wall thickness, and the groove are dimensioned in such a way that focusing and correct lateral alignment may be sufficiently executed. Optical alignment may thus be preferably set automatically. In particular, the optical module may have a self-adjusting design. In addition, a longer diffusion path may be advantageously achieved. The longest possible diffusion paths and small cross-section areas for joints having a sealing function contribute considerably to reducing water vapor diffusion, so that this aspect may be advantageously taken into account when designing the edge, in particular a height and wall thickness of the edge and of the peripheral groove.

If the pre-assembled parts, namely the edge of the lens holder and the adhesive-filled groove of the housing, are positioned relative to one another, the sealant is quickly cured with the aid of a suitable method, for example, using UV radiation (UV curing) or inductive curing.

In a preferred refinement of the present invention, an external frame surrounding a core of the housing has a transparent design. The frame is preferably made of plastic. This design is advantageous in particular for UV curing, because the external frame thus designed is transparent to UV radiation, which accelerates the curing process. The plastic frame may be extruded around the conventional ceramic housing or the ceramic may be pressed into a plastic frame. Other comparable glass-ceramic technologies are, however, also conceivable. The extruded plastic frame is preferably designed in such a way that suitable holding elements are mounted for handling during assembly, focusing, and testing, which may be removed after the final test of the part.

In an advantageous refinement, the lens holder and its edge are immersed into the groove when assembled. The free end of the lens holder is enveloped by sealant, in particular by adhesive. Due to the preferred contour of the groove, part of the glued joint is directly between the lens holder and the (ceramic) housing even if the groove to be filled with adhesive is designed as a transparent plastic frame. A particularly stable connection having a sealing effect is thus established. In addition, the connection provides a long diffusion path, resulting in the connection being advantageously highly diffusion-resistant.

The optical module according to the present invention is preferably used for digital cameras or night-vision devices. Other areas of application are also possible.

### BRIEF DESCRIPTION OF THE DRAWINGS

FIG. 1 shows a schematic view of a preferred specific embodiment of an optical module.

FIG. 2 shows a top view of a mounting surface of a housing of the specific embodiment according to FIG. 1.

### DETAILED DESCRIPTION

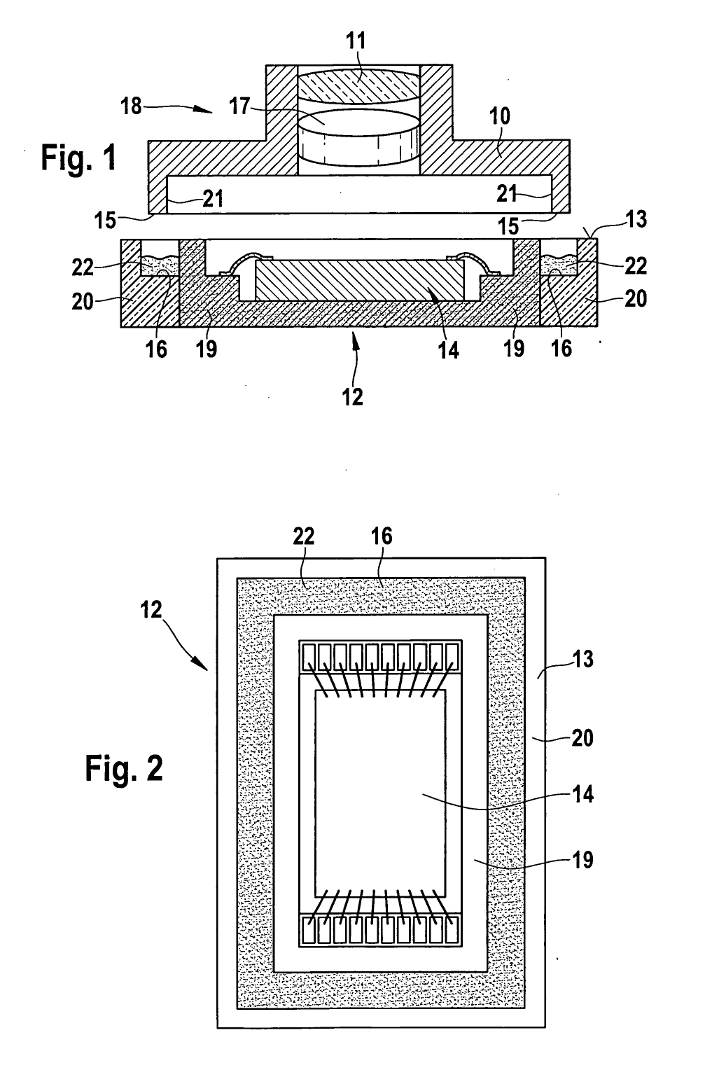

FIG. 1 shows an exploded view of an optical module having a lens holder 10 having at least one lens 11, and a housing 12, preferably a ceramic housing. Furthermore, an image sensor unit 14 having a circuit board and an imager (image sensor) (not shown) is provided. The imager in turn includes an imager chip (not illustrated) made, for example, of light-sensitive silicon, and a light-transparent protective coating. Functional electronic components and a terminal for transferring data, for example image data, and power for operating the electronic component of the system are located on the circuit board.

Lens 11 of an objective 17 is directly connected to lens holder 10. This results in a pre-assembled component 18, which may be connected to housing 12 as a single piece.

Lens holder 10 has a peripheral edge 15 on a side facing housing 12 in the assembled state, which is insertable into a corresponding peripheral groove 16 located in mounting surface 13 of housing 12. Groove 16 is filled with a sealant 22, in particular with an adhesive. During assembly, pre-assembled component 18 made up of lens holder 10 with lens 11 and housing 12 are positioned relative to one another in such a way that edge 15 engages with adhesive-filled groove 16. An adhesive filling height is designed in such a way that adhesive 22 does not flow over edges 15 of lens holder 10 during the joining process. After the joining process, adhesive 22 is rapidly cured using a suitable method such as UV curing or inductive curing. This curing process is accelerated by the transparent design of an external frame 20 surrounding a core 19 of housing 12 which is therefore transparent to UV radiation. Frame 20 is made of plastic, for example. Groove 16 has a U-shaped design, an internal leg being formed from housing core 19, and the other leg, near the periphery, from frame 20.

In the assembled state, lens holder 10 and its edge 15 are immersed into groove 16. Free end 21 of lens holder 10 is thus fully enveloped by adhesive 22. The base of U-shaped groove 16 is formed by transparent frame 20 and is used as a trough for the adhesive filling. In the assembled state, part of the adhesive joint is located between lens holder 10 and housing 12, in particular housing core 19.

Edge 15 and groove 16 are dimensioned in such a way that optical alignment is automatically settable. A desired focusing of lens 11 may be set automatically during the joining process of lens holder 10 to housing 12. The desired focusing is ascertained via image sensor unit 14 actively operated during the joining process. During focusing, one of the components, lens holder 10 or ceramic housing 12, is rigidly secured and the other component 10 or 12 is aligned via a dynamic positioning device. At the same time, lateral alignment of lens holder 10 with respect to housing 12 is automatically set.

FIG. 2 shows a top view of housing 12 in the direction of a mounting surface 13, which is situated in the plane of the drawing. A peripheral groove 16 into which a corresponding edge 15 (not shown) of a lens holder 10 is inserted is located on mounting surface 13 of housing 12. Groove 16 is filled with adhesive 22. External (plastic) frame 20 is transparent and thus pervious to UV radiation, which promotes curing after the joining process. The inside of groove 16 is formed by a housing core 19. An image sensor unit 14 is situated in a central area.

What is claimed is:

1. An optical module comprising:
a housing having a mounting surface;
an image sensor unit; and
a lens holder having at least one lens, the lens holder having a peripheral edge on a side facing the housing in an assembled state, which is insertable into a corresponding groove situated in the mounting surface of the housing.

2. The module according to claim 1, wherein the groove is filled with a sealant.

3. The module according to claim 2, wherein the sealant is an adhesive.

4. The module according to claim 1, wherein an external frame surrounding a housing core of the housing has a transparent design.

5. The module according to claim 1, wherein, in the assembled state, the lens holder and its peripheral edge are immersed in the groove.

6. The module according to claim 1, wherein the peripheral edge and the groove are dimensioned in such a way that optical alignment is automatically settable.

7. A method for assembling an optical module including a lens holder having at least one lens, a housing having a mounting surface, and an image sensor unit, the method comprising:
inserting a peripheral edge of the lens holder into a corresponding groove situated in the mounting surface of the housing; and
filling the groove with a sealant.

8. The method according to claim 7, wherein the sealant is an adhesive.

9. The method according to claim 7, wherein the lens of an objective is directly connected to the lens holder, which results in a pre-assembled component, which is connected to the housing as a single piece.

10. The method according to claim 7, wherein a desired focusing of the lens is set automatically during a joining process of the lens holder to the housing.

11. The method according to claim 10, wherein the desired focusing is ascertained via the image sensor unit which is actively operated during the joining process.

12. The method according to claim 7, wherein one of the lens holder and housing is rigidly secured and the other of the lens holder and housing is aligned via a dynamic positioning device.

13. The method according to claim 10, wherein a quick curing of the sealant takes place after the joining process.
